(19) United States
(12) Patent Application Publication
(10) Pub. No.: US 2025/0139591 A1
(43) Pub. Date: May 1, 2025

(54) COMPUTER-IMPLEMENTED METHOD, DEVICE, AND COMPUTER PROGRAM FOR INSTALLING A WIPER BLADE ON A WIPER ARM OF A MOTOR VEHICLE, AND METHOD FOR INSTALLING A WIPER BLADE

(71) Applicant: Robert Bosch GmbH, Stuttgart (DE)

(72) Inventors: Manuel Hans Reith, Lauf (DE); Jean-Luc Augier, Beinheim (FR); Michael Kruse, Sinzheim (DE)

(21) Appl. No.: 18/923,832

(22) Filed: Oct. 23, 2024

(30) Foreign Application Priority Data
Oct. 26, 2023 (DE) 10 2023 210 585.3

(51) Int. Cl. G06Q 10/20; G06K 7/14; H04L 9/00

(52) U.S. Cl. CPC G06Q 10/20; G06K 7/1417; H04L 9/50; H04L 2209/84

(57) ABSTRACT

Computer-implemented method for installing a wiper blade on a wiper arm of a motor vehicle, wherein the wiper arm is moved to a service position for installing the wiper blade. It is suggested that a label applied at least indirectly to the wiper blade and/or to the wiper blade package be scanned and that the wiper arm be moved to the service position as a function of the scanned label. Furthermore, a device and a computer program are specified for the computer-implemented method. In addition, a method is specified for mounting a wiper blade on a wiper arm.

### BACKGROUND

The invention relates to a computer-implemented method, device and computer program for installing a wiper blade on a wiper arm of a motor vehicle, wherein the wiper arm is moved to a service position for installing the wiper blade. Specifically, the invention relates to the field of passenger cars and trucks.

EP 0 268 131 A1 discloses a wiper system for motor vehicles. In the known wiper system, during normal wiping operation the wiper oscillates between two reversing positions; however, it is stopped in a recessed parked position outside of the wiping area when the power switch is turned off.

In the case of a wiper system wherein the wiper is movable in the parked position outside of the wiping area, it is conceivable for the wiper arm to be moved out of the parked position to a service position on the pane of glass in order to change a wiper blade of the wiper. The movement to the service position can be done manually via a steering rod switch, which may require appropriate programming of software in an electronic control unit (ECU) of the wiper system. The software cannot be changed by the driver. The wiper system can only be operated with the ignition turned on, in particular with regard to ignition plus (terminal 15).

### SUMMARY

The computer-implemented method according to the invention with the features of the disclosure, the device according to the invention, the computer program according to the invention, and the method according to the invention have the advantage that they provide improved functionality. Installation of a wiper blade on a wiper arm of a wiper system can be facilitated in an improved manner. In particular, the wiper blade may be installed simply and/or reliably.

A service position may be a service position on a pane of glass of the motor vehicle. The service position can be pre-determined in such a way to allow as comfortable an installation as possible of the wiper blade and, if necessary, as comfortable an uninstallation of a previous wiper blade as possible. The service position is not necessarily fixed.

A motor vehicle, on which the method is used, can also comprise a plurality of wiper arms, in particular two wiper arms, on a windshield. The method can then also be used on a plurality of wiper arms simultaneously or sequentially. The wiper arms can be moved into their service positions simultaneously or sequentially. The method can also be used on wiper arms of different panes, in particular on a windshield and on a rear window.

It is advantageous for the label to be scanned at least when the ignition of the motor vehicle is turned off. This allows the wiper blade to be changed from the outside in a comfortable manner.

It is advantageous that the label be scanned by a sensor of the motor vehicle, in particular a sensor detecting the environment of the motor vehicle, and/or by means of a mobile device, in particular a cell phone. For example, an outward facing camera or external camera may be utilized. Specifically, a sensing device, in particular a camera, that scans the label can be mounted in a mirror foot. The scanning can also take place via a mobile handheld device or a mobile device connectable to the Internet, in particular a cell phone or a tablet.

It is advantageous that it be checked whether the scanned label is an allowable label for the motor vehicle. This may prevent faulty installation of an incorrect wiper blade. In particular, the safety of the motor vehicle can be ensured during operation, since, for example, the installation of too short of a wiper blade can be avoided.

Advantageously, a user is shown a result of the verification, in particular on a mobile device. This may inform the user from the outset whether or not a wiper blade is suitable for their motor vehicle or the respective wiper arm of their motor vehicle. The user may already be able to check this at the time of ordering or before purchasing a wiper blade if the scanning is done, for example, with a mobile device, such as a cell phone or tablet.

It is advantageous for the wiper arm to be moved to the service position if the result of the verification is that the scanned label is an allowable label for the motor vehicle. For example, the installation of a permissible wiper blade may occur in a particularly simple manner by scanning the label on the motor vehicle, which may be done with a device in the motor vehicle or a mobile device.

It is advantageous that at least one installation instruction for the wiper blade be displayed to a user as a function of scanning the label. This may further simplify installation for the user. The display of the installation instructions can be on a mobile end device and/or on a display screen in the vehicle.

Advantageously, the label is stored in a QR code and/or an RFID and/or a blockchain, in particular a VeChain. The label may be reliably scanned as a result. The blockchain may also enable tracking of a wiper blade. For this purpose, data may also be transmitted to a manufacturer, if necessary, in order to enable, for example, quality monitoring and/or quality improvement.

It is advantageous that a label, in particular a label stored in a block chain, of a previous wiper blade be scanned when the wiper blade is installed on the wiper arm as a replacement for the previous wiper blade. This may allow tracking of a wiper blade over its service life.

It is advantageous that wear of the wiper blade be sensed and/or that an automated and/or manually triggered reordering of the wiper blade occur, which preferably occurs when the sensed wear of the wiper blade reaches a predetermined wear limit. This further improves safety for operation of the motor vehicle.

Depending on the configuration, one or more of the following features and advantages may be realized.

The possibility of operating the wiper system even when the ignition is not turned on can result in new possibilities with regard to functionality and use of a wiper system. The networking of the sensors present in the vehicle and the corresponding logic as well as control of the wiper motor preferably results in new functionalities, which may also be offered on the market as a separate software package or software functionality. The new functionality may serve as an additional service for the vehicle user. For example, controlling the service position or service positions of a wiper system can be possible via an external signal so that actuation is possible independent of the steering rod switch.

It is particularly advantageous that a wiper motor be integrated in a communicable environment, which can process data from other sensor units in the vehicle or receive external signals and then start activities, in particular the output of signals. The prerequisites for this are met, for example, when the wiper drive is VSS enabled and can be controlled by the zone ECU or an app on a vehicle computer. A VSS interface is for vehicle-specific signals (VSS) and is an exemplary embodiment for a standard software/signal interface.

For example, possible embodiments with advantageous functionality may achieve at least one of the following:

A service app (computer program (computer program product)) may be available for a wiper blade change and may particularly be offered for download. The user of the vehicle has the option to obtain an app (computer program) for their mobile device, in particular a smartphone, which can assist with the change of the wiper blade. The app can first determine the associated wiper blade for the vehicle.

A newly acquired wiper blade may have a replacement part label, such as a QR code, on the packaging. The QR code shown on the packaging allows the label to be scanned in with the smartphone app. In an advantageous embodiment, this app is also networked with the vehicle.

By scanning the QR code, it can be confirmed that the correct wiper blade is present for installation. Furthermore, the corresponding service position of the wiper system may be activated using the app.

Activation occurs, for example, at the level of a vehicle computer, which in turn can send a signal via the system architecture to the drive ECU of the wiper drive. The user thus has the advantage of avoiding installation of an incorrect wiper blade. In addition, the user does not need to activate the ignition system of the vehicle in order to change the wiper blade.

In addition to or alternatively to such app functions, by scanning the QR code, at least one further reference (link) can also be displayed and/or accessed regarding instructions on generally accessible platforms, such as a social network, a video portal, a manufacturer's site, or another Internet portal.

An app may also be installed in the vehicle computer or may be installed upon user requests, for example. The app can in particular assist with wiper blade changes.

The functions can additionally or alternatively also be designed independently without external communication of the vehicle. Thus, the content and/or functionality of an app, which is for a mobile device, in particular a cell phone, in particular a smart phone, may also be installed on the vehicle computer as an app serving as an app for a vehicle computer. An app may also be executed as an app in a cloud associated with the vehicle. Furthermore, distributed systems are possible. These embodiments may reduce external communication in the respective application.

In one advantageous embodiment, for example, a QR code on the package of the wiper blade can be displayed by a camera already located in the vehicle, e.g. a camera for outdoor use, behind the windshield or in the interior. The functionality, such as a compatibility check of the new wiper blade and/or controlling the service position, may then be selected and activated with the on-board computer of the vehicle.

Functionality may be realized by means of the combination of a QR code on the packaging of a wiper blade and connectivity of the vehicle. At least one further service function may be enabled by this. For example, such further service function may trigger automated or manual reordering of a wiper blade.

Additionally, or alternatively, a subscription model may be enabled, for example, allowing for periodic reordering of the wiper blade. For example, a wiper blade may be ordered after a certain amount of operating time, in particular a certain number of hours of operation, and/or a certain distance of travel, in particular miles traveled, and/or a certain amount of time, in particular days, after a commissioning of the motor vehicle or the last wiper change. This also further improves the safety of vehicle operation.

Thus, in a preferred configuration, an architecture for connection to a wiper motor, a zone control unit (zone ECU) and a vehicle computer, as well as optionally a parent cloud, can be provided.

### BRIEF DESCRIPTION OF THE DRAWINGS

Preferred exemplary embodiments of the invention are explained in more detail in the following description with reference to the accompanying drawings, in which corresponding elements are shown with the same reference numerals. Shown are:

FIG. 1 an automotive vehicle in a partial schematic spatial representation, wherein wiper arms are moved to their respective service position in which wiper blades may be installed;

FIG. 2 a device for performing a computer-implemented method according to an exemplary embodiment; and

FIG. 3 various wiper blades in their packages and a mobile device of a user, wherein selecting a wiper blade that is permitted in FIG. 1 using the computer-implemented method is illustrated.

### DETAILED DESCRIPTION

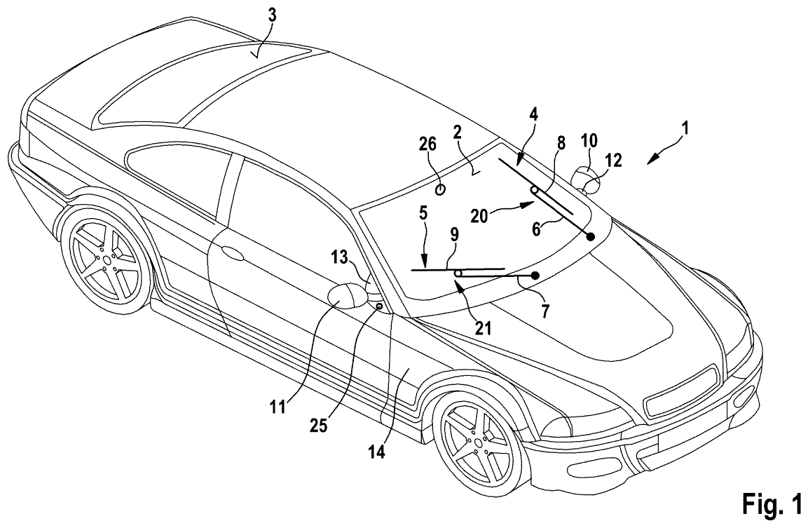

FIG. 1 shows a motor vehicle 1 in a partial, schematic, spatial representation. The motor vehicle 1 comprises a pane of glass 2, which is configured as a windshield 2. Further, the motor vehicle 1 comprises a pane of glass 3, which is configured as a rear window 3. The vehicle comprises wipers 4, 5, which in this exemplary embodiment are provided on the pane of glass 2 configured as a windshield 2. In a modified embodiment, for example, only a wiper 4 may be provided on the pane of glass 2. Furthermore, in a modified embodiment, at least one wiper may also be provided on the pane of glass 3 configured as a rear window 3 in a corresponding manner. The motor vehicle 1 may in particular be configured as a passenger car or truck.

The wipers 4, 5 have wiper arms 6, 7 and releasable wiper blades 8, 9 attached to the wiper arms 6, 7. The wiper blades 8, 9 are connected to the wiper arms 6, 7 via a suitable mechanism, which is preferably configured such that a wiper change is itself feasible by a user of the motor vehicle 1, so that repair shop work or service work in a specialist repair shop is not necessarily required for this purpose. However, the installation of the wiper blades 6, 7 may also be carried out by a repair shop or garage, for example in the context of vehicle service.

The motor vehicle 1 also comprises mirrors 10, 11, which are connected to a body 14 of the motor vehicle 1 via mirror feet 12, 13.

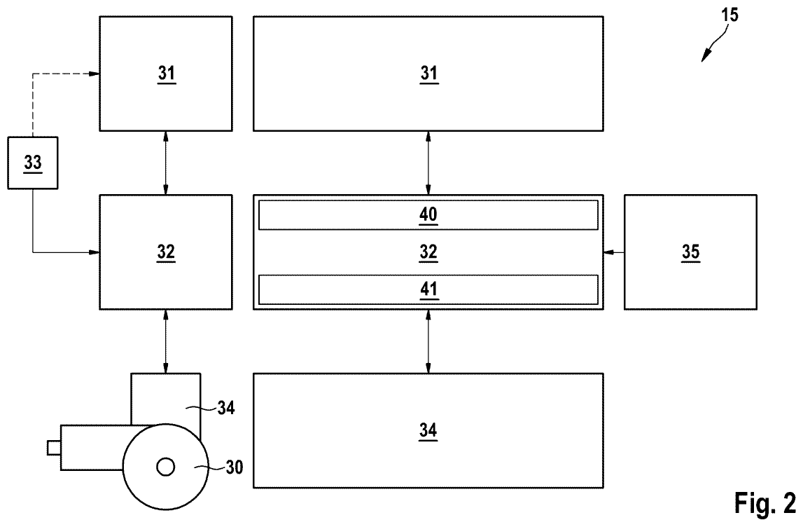

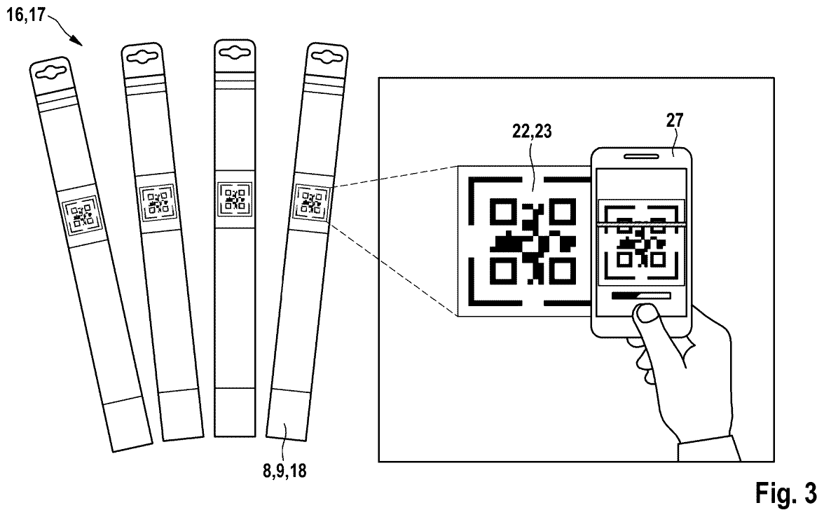

Preferred exemplary embodiments are also further described below with reference to FIGS. 2 and 3.

FIG. 2 shows a device 15 for performing a computer-implemented method according to an exemplary embodiment. FIG. 3 shows various wiper blades 16 in their packages 17. In this respect, for example, a package 18 contains the suitable or approved wiper blades 8, 9 for the motor vehicle.

A computer-implemented method according to an exemplary embodiment is used to install the wiper blades 8, 9 on the wiper arms 6, 7 of the motor vehicle 1. To install the wiper blades 8, 9, the wiper arms 6, 7 are moved to their respective service position 20, 21. Moving the service positions 20, 21 can occur simultaneously or sequentially.

To trigger the movement of the wiper arms 6, 7 into the service positions 20, 21, a label 22 affixed to the package 18 of the wiper blade 8, 9 is scanned. In this exemplary embodiment, the label 22 is stored (encoded) in a QR code 23. In modified embodiments, the label 22 may additionally or alternatively also be stored in an RFID and/or a block chain, in particular a VeChain.

For example, the label 22 may be scanned via sensors 25, 26 of motor vehicle 1 and/or via a mobile device 27 of a user.

In the embodiment shown in FIG. 3, the scanning of the label 22 is carried out via a mobile device 27 of the user configured as a smartphone 27. In this case, the correct package 18 for the user's motor vehicle 1 with the suitable wiper blades 8, 9 can already be selected from the packages 17.

If the user is next to the motor vehicle 1 with the wiper blades 8, 9 included in the package 18, then they may scan the label 22 using the sensor 25 or the sensor 26 of the motor vehicle 1, which senses the environment of the motor vehicle 1, or by means of their mobile device 27. In this case, the label 22 may preferably also be scanned when the ignition of the motor vehicle 1 is turned off. For example, one or more sensors 25 may be provided in the mirror feet 12, 13. For example, the sensor 26 may be provided behind the pane of glass 2.

Then, there is preferably a verification that the scanned label 22 is an allowable label 22 for the motor vehicle 1. The result of the verification may be displayed to the user on their mobile device 27.

When an allowable label 22 is scanned, the wiper arms 6, 7 are moved to their respective service position 20, 21. The service positions are preferably selected in such a way that a change of the wiper blades 8, 9 is possible in as comfortable a manner as possible for the user. If necessary, an installation instruction for the wiper blade 8, 9 can also be displayed to the user on their mobile device 27.

When the wiper blades 8, 9 are changed, in particular, a label 22 of the previous wiper blades 8, 9 stored in a block chain can be detected. Since the block chain, in particular a VeChain, encodes a uniquely assigned label 22 associated with the individual wiper blade 8, 9, a product can thus be individually tracked over the life of the wiper blades.

Wear on the wipers 8, 9 may also be detected and then an automated and/or manually triggered reordering of the wipers 8, 9 may take place. For example, new wiper blades 8, 9 can be regularly ordered at certain intervals.

FIG. 2 illustrates a possible embodiment of the device 15 that at least partially performs the computer-implemented method. Only one drive motor (wiper motor) 30 is shown for the wipers 4, 5. The wipers 4, 5 may be driven together by the drive motor 30.

A vehicle computer 31 may be connected to a zone ECU 32 via IP-based ethernet. A steering lever switch 33 may send signals to vehicle computer 31 and/or zone ECU 32. Zone ECU 32 may control drive motor 30 via a UN/CAN signal. A motor ECU 34 is provided on the drive motor 30.

A signal may be sent to the zone ECU 32 via at least one further ECU unit or terminals 35 via CAN.

A computer program, in particular an app (application) which can perform the computer-implemented method, may be installed on vehicle computer 31. A VSS interface 40 may be utilized by vehicle computer 31 for zone ECU 32. Motor ECU 34 may be controlled via a wiper motor UN driver 41 via the UN/CAN signal-based link. In this case, application-specific steps may be carried out on the motor ECU 34, which enable the drive motor 30 to be actuated via standard functions or standard software.

Accordingly, the zone ECU may be controlled via the further ECU unit or terminal 35 via a CAN signal. The further ECU unit or terminal 35 may enable connection to the sensors 25, 26 of the motor vehicle 1 and/or to the mobile device 27 of the user and/or to a cloud and/or other internet services accessible via the internet.

For example, the BUS system of the motor vehicle 1 can be based on CAN, CAN FD, FlexRay, Ethernet, or LIN. In particular, different connection types or protocols for different connections can also be used.

The invention is not limited to the embodiments described.

1. A computer-implemented method for installing a wiper blade (8, 9) on a wiper arm (6, 7) of a motor vehicle (1), wherein the wiper arm (6, 7) is moved to a service position (20, 21) for installing the wiper blade (8, 9),
wherein
a label (22) applied at least indirectly to the wiper blade (8, 9) and/or to the wiper blade (8, 9) package is scanned and that the wiper arm (6, 7) is moved to the service position (20, 21) as a function of the scanned label (22).

2. The computer-implemented method according to claim 1,
wherein
the label (22) is scanned at least when the ignition of the motor vehicle (1) is turned off.

3. The computer-implemented method according to claim 1,
wherein
the label (22) is scanned by a sensor (25, 26) of the motor vehicle (1), and/or by means of a mobile device (27).

4. The computer-implemented method according to claim 1,
wherein
there is a verification of whether the scanned label (22) is an allowable label (22) for the motor vehicle (1), and
a) a user is shown a result of the verification a mobile device (27), and/or
b) the wiper arm (6, 7) is moved to the service position (20, 21) if the result of the verification is that the scanned label (22) is an allowable label (22) for the motor vehicle (1).

5. The computer-implemented method according to claim 1,
wherein
at least one installation instruction for the wiper blade (8, 9) is displayed to a user as a function of scanning the label (22).

6. The computer-implemented method according to claim 1,
wherein the label (22) is stored in a QR code (23) and/or an RFID and/or a blockchain.

7. The computer-implemented method according to claim 1,
wherein
a label (22) stored in a block chain, of a previous wiper blade (8, 9) is scanned when the wiper blade (8, 9) is installed on the wiper arm (6, 7) as a replacement for the previous wiper blade (8, 9).

8. The computer-implemented method according to claim 1,
wherein
wear of the wiper blade (8, 9) is sensed and/or that an automated and/or manually triggered reordering of the wiper blade (8, 9) occurs, preferably when the sensed wear of the wiper blade (8, 9) reaches a predetermined wear limit.

9. A device configured to perform all steps of a method according to claim 1.

10. A non-transitory, computer-readable medium containing instructions that when executed by a computer cause the computer to control installation of a wiper blade (8, 9) on a wiper arm (6, 7) of a motor vehicle (1), wherein the wiper arm (6, 7) is moved to a service position (20, 21) for installing the wiper blade (8, 9),
by scanning a label (22) applied at least indirectly to the wiper blade (8, 9) and/or to the wiper blade (8, 9) package and controlling movement of the wiper arm (6, 7) to the service position (20, 21) as a function of the scanned label (22).

11. A method for installing a wiper blade on a wiper arm of a motor vehicle, wherein a person installs a wiper blade on the wiper arm,
wherein
the wiper arm (6, 7) is moved to a service position (20, 21) by means of a computer-implemented method according to claim 1, in order to install the wiper blade (8, 9) on the wiper arm (6, 7).
